(19) United States
(12) Patent Application Publication
(10) Pub. No.: US 2007/0057892 A1
(43) Pub. Date: Mar. 15, 2007

(54) Liquid crystal display and method thereof

(76) Inventors: Kyoung-ju Shin, Hwaseong-si (KR); Hyun-wuk Kim, Yongin-si (KR); Yoon-sung Um, Yongin-si (KR)

Correspondence Address: CANTOR COLBURN, LLP, 55 GRIFFIN ROAD SOUTH, BLOOMFIELD, CT, 06002, US

(21) Appl. No.: 11/506,535

(22) Filed: Aug. 18, 2006

(30) Foreign Application Priority Data
Sep. 15, 2005 (KR) 10-2005-0086308

(51) Int. Cl. G09G 3/36

(52) U.S. Cl. 345/96

(57) ABSTRACT

An LCD apparatus includes a first pixel including a first TFT, a first pixel electrode connected to the first TFT and having an incision pattern, and an extended electrode having at least one part formed along the incision pattern, a second pixel including a second TFT, and a second pixel electrode to which a same data voltage as a data voltage applied to the extended electrode of the first pixel is applied, a data driver applying a data voltage to the first and second pixels, and a signal controller controlling the data driver so that data voltages with different polarities are applied to the first and second pixels. Accordingly, an LCD capable of increasing a response speed and/or an aperture ratio is provided.

This application claims priority to Korean Patent Application No. 2005-0086308, filed on Sep. 15, 2005 and all the benefits accruing therefrom under 35 U.S.C. §119, and the contents of which in its entirety are herein incorporated by reference.

### BACKGROUND OF INVENTION

1. Field of Invention

The present invention relates to a liquid crystal display (“LCD”) and method thereof, and more particularly, to an LCD capable of increasing a response speed and/or an aperture ratio, and a method of enhancing lateral fields in the LCD.

2. Description of the Related Art

Liquid crystal displays (“LCDs”) include a liquid crystal panel having a thin-film transistor (“TFT”) substrate on which TFTs are formed, a color filter substrate on which color filter layers are formed, and liquid crystal layers disposed between the TFT substrate and the color filter substrate. Since the liquid crystal panel is a non-light-emitting device, a backlight unit for supplying light may be disposed rear the TFT substrate. A transmission amount of light emitted from the backlight unit is adjusted according to the arrangement state of the liquid crystal layers.

Recently, LCDs are being applied to display apparatuses such as televisions. The LCD has improved in a viewing angle, color reproducibility, brightness, etc., however, still requires an improvement in response speed.

In a patterned vertically aligned (“PVA”) mode, which is a mode for enhancing a viewing angle among vertically aligned (“VA”) modes, incision patterns are respectively formed in pixel electrodes and common electrodes. By adjusting the lying direction of liquid crystal molecules by using fringe fields generated by the incision patterns, a viewing angle is enhanced.

However, in the PVA mode, the fringe fields are weakened in regions far from the incision patterns and the response of liquid crystal is delayed. Due to the delay in the movement of liquid crystal, the sizes of pixel electrodes and aperture ratio are limited.

### BRIEF SUMMARY OF THE INVENTION

Accordingly, it is an aspect of the present invention to provide an LCD which is capable of increasing a response speed and/or an aperture ratio by enhancing lateral fields.

Another aspect of the present invention is to provide a method of enhancing lateral fields in a liquid crystal layer of an LCD.

Other uses for the present invention are also possible, as those skilled in the art will appreciate.

Additional features of the invention will be set forth in the description which follows, and in part will be apparent from the description, or may be learned by practice of the invention.

The foregoing and/or other aspects of the present invention can be achieved by providing an LCD apparatus including at least one gate line and at least one data line insulated from each other and intersecting each other, a first pixel including a first TFT disposed at an intersection of a gate line and a data line, a first pixel electrode connected to the first TFT and having an incision pattern, and an extended electrode having at least one part formed along the incision pattern, a second pixel including a second TFT disposed at an intersection of a gate line and a data line, and a second pixel electrode to which a same data voltage as a data voltage applied to the extended electrode of the first pixel is applied, a data driver applying a data voltage to the first pixel and the second pixel, and a signal controller controlling the data driver so that data voltages with different polarities are applied to the first pixel and the second pixel.

According to an aspect of the present invention, the LCD apparatus further comprises a third TFT receiving a same gate on voltage and the same data voltage as those applied to the second TFT, wherein a part of the extended electrode is included in the third TFT.

According to an aspect of the present invention, the extended electrode is integrated with a drain electrode of the second TFT, and the extended electrode forms a same layer as the data line.

According to an aspect of the present invention, the extended electrode is connected to the second pixel electrode, and the extended electrode forms a same layer as the second pixel electrode.

According to an aspect of the present invention, the first pixel and the second pixel are connected to a same data line and are adjacent to each other in an extended direction of the same data line.

According to an aspect of the present invention, the first pixel is connected to a second gate line and the second pixel is connected to a first gate line.

According to an aspect of the present invention, the first pixel and the second pixel are connected to a same gate line and are disposed in an extended direction of the same gate line.

According to an aspect of the present invention, the first pixel is connected to a first data line and the second pixel is connected to a second data line.

According to an aspect of the present invention, the first pixel electrode is chevron-shaped. The data line connected to the first TFT may be formed in correspondence to an edge of the first pixel electrode. Alternatively, the data line connected to the first TFT may be formed in a straight line. The polarity of a data voltage applied to the first pixel may be different from a polarity of a data voltage applied to pixels adjacent to the first pixel in an extended direction of the data line connected to the first TFT and in an extended direction of the gate line connected to the first TFT.

According to an aspect of the present invention, the incision pattern is at an acute angle to the extended direction of the gate line, such as at an angle of about 45° to the extended direction of the gate line connected to the first TFT.

According to an aspect of the present invention, the first pixel electrode is chevron-shaped, and the incision pattern is parallel to an edge of the first pixel electrode. The first pixel electrode may be divided into a first area and a second area both having a substantially same size and electrically connected to each other, wherein the incision pattern is disposed between the first area and the second area. Widths of the first area and the second area may be respectively 60 or more.

According to an aspect of the present invention, a width of the extended electrode is narrower than a width of the incision pattern.

According to an aspect of the present invention, a width of the incision pattern is 8 or less.

The foregoing and/or another aspects of the present invention can be achieved by providing an LCD apparatus including at least one gate line and at least one data line insulated from each other and intersecting each other, a first TFT disposed at an intersection of a gate line and a data line and to which a data voltage with a first polarity is applied, a second TFT disposed at an intersection of a gate line and a data line and to which a data voltage with a second polarity different than the first polarity is applied, a pixel electrode connected to the first TFT and having a first area and a second area opposite to each other, and an extended electrode electrically connected to the second TFT and disposed between the first area and the second area.

According to an aspect of the present invention, the first TFT and the second TFT are disposed in an extended direction of a same data line, such that the first TFT is connected to a second gate line and the second TFT is connected to a first gate line.

According to an aspect of the present invention, the first TFT and the second TFT are disposed in an extended direction of a same gate line, such that the first TFT is connected to a first data line and the second TFT is connected to a second data line.

According to an aspect of the present invention, the pixel electrode is chevron-shaped and the at least one data line is formed in a straight line, and the pixel electrode is subjected to dot inversion.

The foregoing and/or another aspects of the present invention can be achieved by providing an LCD apparatus including a first substrate including a pixel electrode having a pixel electrode incision pattern, and an extended electrode formed along the pixel electrode incision pattern and to which a data voltage with a different polarity than the pixel electrode is applied, a second substrate including a common electrode disposed opposite to the first substrate, wherein a common electrode incision pattern is formed in the common electrode, and a liquid crystal layer positioned between the first substrate and the second substrate and of which dielectric anisotropy is negative.

The foregoing and/or another aspects of the present invention can be achieved by providing a method of enhancing lateral fields in a liquid crystal layer of a liquid crystal display apparatus by applying a data voltage of a first polarity to a pixel electrode of a first pixel, the pixel electrode having an incision pattern, and applying a data voltage of a second polarity opposite to the first polarity to an extended electrode extending in the first pixel in a direction following the incision pattern, wherein a voltage difference between the extended electrode and the pixel electrode enhances the lateral fields.

Applying a data voltage of a second polarity to the extended electrode may include applying the data voltage of the second polarity to a second pixel electrode of a second pixel adjacent the first pixel, the extended electrode electrically connected to the second pixel electrode.

It is to be understood that both the foregoing general description and the following detailed description are exemplary and explanatory and are intended to provide further explanation of the invention as claimed.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIG. 1 is a block diagram of an exemplary LCD according to a first exemplary embodiment of the present invention;

FIG. 2 is a layout of an exemplary TFT substrate according to a first exemplary embodiment of the present invention;

FIG. 3 is a cross-sectional view cut along line III-III of FIG. 2;

FIG. 4 is a cross-sectional view of an exemplary liquid crystal panel cut along line IV-IV of FIG. 2;

FIGS. 5A and 5B are views for describing an inversion method of an exemplary LCD according to a first exemplary embodiment of the present invention;

FIG. 6 is a layout of an exemplary TFT substrate according to a second exemplary embodiment of the present invention;

FIG. 7 is a layout of an exemplary TFT substrate according to a third exemplary embodiment of the present invention;

FIG. 8 is a cross-sectional view cut along line VIII-VIII of FIG. 7;

FIG. 9 is a layout of an exemplary TFT substrate according to a fourth exemplary embodiment of the present invention;

FIG. 10 is a cross-sectional view of an exemplary liquid crystal panel cut along line X-X of FIG. 9;

FIG. 11 is a layout of an exemplary TFT substrate according to a fifth exemplary embodiment of the present invention;

FIG. 12 is a layout of an exemplary TFT substrate according to a sixth exemplary embodiment of the present invention;

FIGS. 13A, 13B and 13C are views for describing an inversion method of an exemplary LCD according to the sixth exemplary embodiment of the present invention;

FIG. 14 is a layout of an exemplary TFT substrate according to a seventh exemplary embodiment of the present invention;

FIG. 15 is a cross-sectional view of an exemplary liquid crystal panel cut along line XV-XV of FIG. 14;

FIG. 16 is a layout of an exemplary TFT substrate according to an eighth exemplary embodiment of the present invention;

FIG. 17 is a cross-sectional view of an exemplary liquid crystal panel cut along line XVII-XVII of FIG. 16; and

FIG. 18 is a layout of an exemplary TFT substrate according to a ninth exemplary embodiment of the present invention.

### DETAILED DESCRIPTION OF THE INVENTION

Reference will now be made more fully to the embodiments of the present invention, examples of which are illustrated in the accompanying drawings, wherein like reference numerals refer to like elements throughout. The embodiments are described below so as to explain the present invention by referring to the figures.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

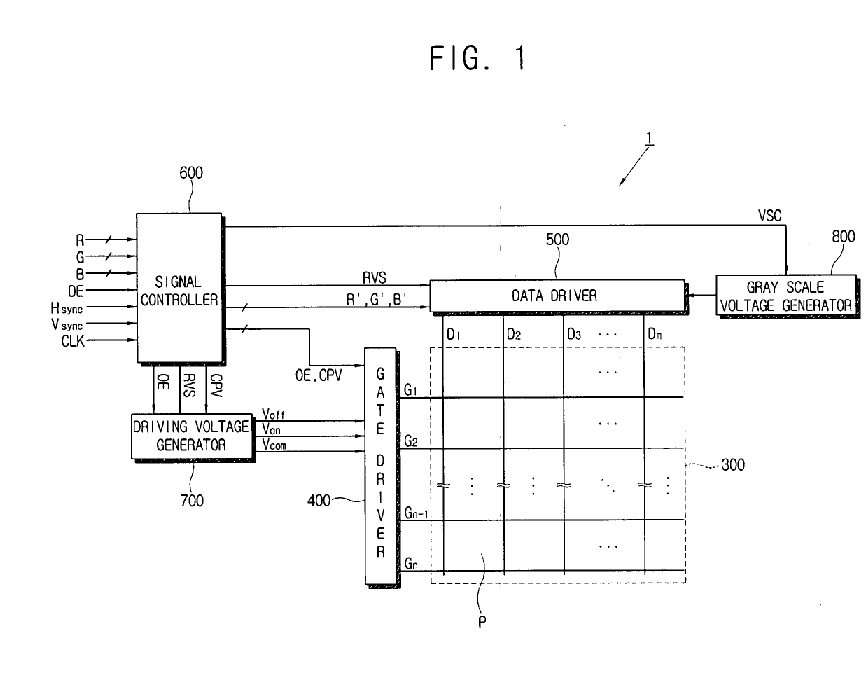

FIG. 1 is a block diagram of an exemplary LCD 1 according to a first exemplary embodiment of the present invention.

The LCD 1 includes a liquid crystal panel 300, a gate driver 400 and a data driver 500 connected to the liquid crystal panel 300, a driving voltage generator 700 connected to the gate driver 400, a gray scale voltage generator 800 connected to the data driver 500, and a signal controller 600 for controlling the above elements.

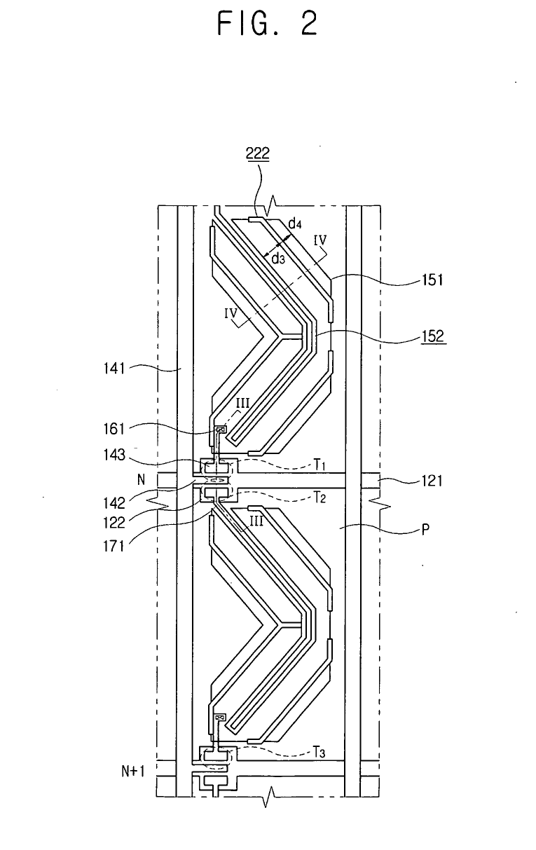

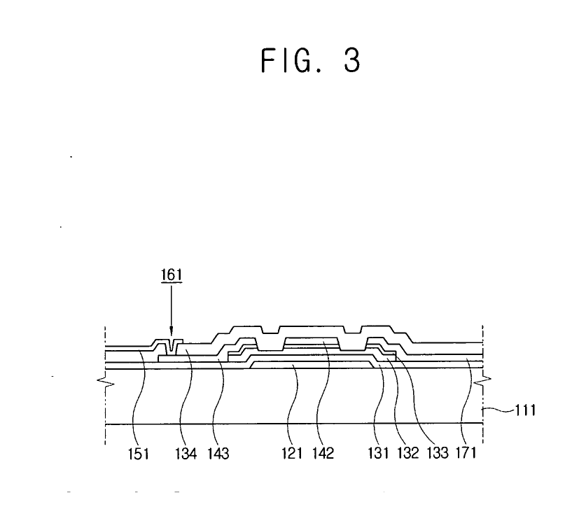

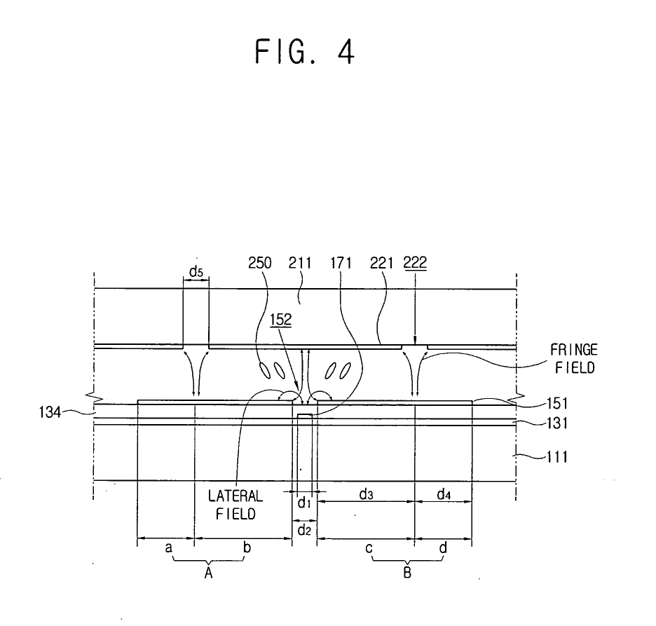

The liquid crystal panel 300 will be described with reference to FIGS. 2, 3, and 4 below. FIG. 2 is a layout of an exemplary TFT substrate according to a first exemplary embodiment of the present invention. FIG. 3 is a cross-sectional view cut along line III-III of FIG. 2. FIG. 4 is a cross-sectional view of an exemplary liquid crystal panel 300 cut along line IV-IV of FIG. 2.

The liquid crystal panel 300 includes a TFT substrate 100, a color filter substrate 200 opposite to the TFT substrate 100, and a liquid crystal layer 250 disposed between the substrates 100 and 200.

In the TFT substrate 100, gate wiring 121 and 122 is formed on a first insulating substrate 111. The gate wiring 121 and 122 may be a single layer or multi-layers made of metal. The gate wiring 121 and 122 includes a gate line 121 extended in a horizontal direction, such as a first direction, in FIG. 2 and gate electrodes 122 of TFTs T1 and T2, as will be further described below, connected to the gate line 121.

Although not illustrated in FIG. 2, a gate metal layer including the gate wiring 121 and 122 formed on the first insulating substrate 111 may further include a common electrode line which forms a storage capacity while overlapped by a pixel electrode 151, wherein the common electrode line is parallel to the gate line 121.

A gate insulation film 131 made of SiNx and the like covers the gate wiring 121 and 122, as well as the common electrode line if provided, on the first insulating substrate 111.

A semiconductor layer 132 made of a semiconductor such as amorphous silicon (“a-Si”) is formed on the gate insulation film 131 over the gate electrode 122, and an ohmic contact layer 133 made of a material, such as silicide or n+ hydrogen a-Si in which n-type impurities are doped at a high density, is formed on the semiconductor layer 132. The ohmic contact layer 133 is divided into three portions as shown in FIG. 3.

Data wiring 141, 142, 143 and 171 is formed on the ohmic contact layer 133 and the gate insulation film 131. The data wiring 141, 142, 143, and 171 may also be a single layer or multi-layers made of metal. The data wiring 141, 142, 143, and 171 includes a data line 141 formed in a vertical direction, such as a second direction substantially perpendicular to the first direction, and defining a pixel P by intersecting the gate line 121, a source electrode 142 being a branch of the data line 141 and extended on the ohmic contact layer 133, a drain electrode 143 separated from the source electrode 142 and formed on one side of the ohmic contact layer 133, and an extended electrode 171 separated from the source electrode 142 and formed on the other side of the ohmic contact layer 133 opposite to the drain electrode 143. The extended electrode 171 connected to a front pixel P, a first pixel, is extended along a pixel electrode incision pattern 152 of a rear pixel P, a second pixel, adjacent to the front pixel P. The extended electrode 171 extends in a direction or directions parallel to the direction or directions that the pixel electrode incision pattern 152 extends. A width d1 of the extended electrode 171 is slightly narrower than a width d2 of the pixel electrode incision pattern 152, such that a path of the extended electrode 171 falls within a projection of a path of the pixel electrode incision pattern 152.

By the structure of the gate electrode 122, the source electrode 142, the drain electrode 143, and the extended electrode 171, a driving TFT T1 and an additional TFT T2 are formed in the pixel P. The driving TFT T1 and the additional TFT T2 share the gate electrode 122 and the source electrode 142. Accordingly, the same gate-on voltage and the same data voltage are applied to the driving TFT T1 and the additional TFT T2, and a data voltage applied to the drain electrode 143 is substantially equal to a data voltage applied to the extended electrode 171.

Accordingly, a data voltage of the front pixel P is applied to the extended electrode 171 of the rear pixel P. The rear pixel P includes a driving TFT T3 that provides a data voltage with a different polarity to a pixel electrode 151 of the rear pixel P that surrounds the extended electrode 171. Thus, an extended electrode 171 in each pixel P of the liquid crystal panel 300 has a data voltage with a different polarity than a data voltage applied to the pixel electrode 151 of each respective pixel P.

A passivation film 134 made of silicon nitride, an a-Si:C:O layer or an a-Si:O:F layer deposited by a plasma enhanced chemical vapor deposition (“PECVD”) method, an acrylic organic insulation layer and the like, is formed on the data wirings 141, 142, 143, and 171 and the semiconductor layer 132 which is not covered by the data wirings 141, 142, 143, and 171. A contact hole 161 for exposing the drain electrode 143 is formed in the passivation film 134.

The pixel electrodes 151 are formed on the passivation film 134. The pixel electrodes 151 are generally made of a transparent conductive material such as, but not limited to, indium tin oxide (“ITO”) or indium zinc oxide (“IZO”).

The pixel electrode incision patterns 152 are formed in the pixel electrodes 151. The pixel electrode incision patterns 152 are used to divide the liquid crystal layer 250 into a plurality of domains together with common electrode incision patterns 222, which will be further described below. The pixel electrode incision patterns 152 are formed at an angle of about 45° with respect to the gate lines 121.

As shown in FIG. 4, the pixel electrode 151 is divided into a first area A and a second area B putting the pixel electrode incision pattern 152 there between. The first area A and the second area B are electrically connected to each other, such as at an area adjacent the drain electrode 143 as shown in FIG. 2, and receive the same data voltage from the drain electrode 143 through the contact hole 161. The first area A is divided into a first domain a and a second domain b putting the common electrode incision pattern 222 there between, and the second area B is also divided into a third domain c and a fourth domain d putting the common electrode incision pattern 222 there between. Here, the first domain a and the fourth domain d are adjacent to adjacent data lines 141, and the second domain b and the third domain c are adjacent to the pixel electrode incision pattern 152 and the extended electrode 171.

Hereinafter, descriptions regarding the third domain c and the fourth domain d will be given and the descriptions can be also applied to the first domain a and the second domain b.

In the color filter substrate 200, common electrodes 221 are formed on a second insulating substrate 211. The common electrodes 221 may be electrically connected to each other such as by forming a single common electrode on the second insulating substrate 211. The common electrodes 221 are formed with a transparent conductive material, such as, but not limited to, ITO or IZO. The common electrodes 221 directly apply voltages to the liquid crystal layer 250 together with the pixel electrodes 151 of the TFT substrate 100. The common electrode incision patterns 222 are formed in the common electrodes 221. The common electrode incision patterns 222 are used to divide the liquid crystal layer 250 into a plurality of domains together with the pixel electrode incision patterns 152 of the pixel electrodes 151. Although not illustrated in the drawings, the color filter substrate 200 may further include a black matrix, a color filter, an overcoat layer and the like. A width d5 of the common electrode incision pattern 222 may be about 10.

The liquid crystal layer 250 is disposed between the TFT substrate 100 and the color filter substrate 200. In the VA mode, the long axis of liquid crystal molecules is arranged perpendicularly in the liquid crystal layer 250 when no voltage is applied. When a voltage is applied, the liquid crystal molecules lie in a direction perpendicular to electric fields due to negative dielectric anisotropy. However, if the pixel electrode incision patterns 152 and the common electrode incision patterns 222 are not formed, the liquid crystal molecules will be disorderly arranged and disclination lines will be created in boundaries which are in a different orientation direction. The pixel electrode incision patterns 152 and the common electrode incision patterns 222 generate fringe fields, such as shown in FIG. 4, when a voltage is applied to the liquid crystal layer 250, thereby to decide an azimuthal angle of liquid crystal orientation. Also, the liquid crystal layer 250 is divided into a plurality of areas according to the arrangement of the pixel electrode incision patterns 152 and the common electrode incision patterns 222.

Lateral fields as well as the fringe fields are applied to the liquid crystal layers 250. In FIG. 4, fringe fields are generated between both the substrates 100 and 200 where the incision patterns 152 and 222 are formed. The wider the widths d2 and d5 of the incision patterns 152 and 222, the stronger the fringe fields. However, increasing the widths d2 and d5 of the incision patterns 152 and 222 can deleteriously affect an aperture ratio. The lateral fields are generated in a horizontal direction between the extended electrode 171 positioned below the pixel electrode incision pattern 152 and the pixel electrode 151 adjacent to the extended electrode 171. As previously described, the extended electrode 171 and the pixel electrode 151 adjacent to the extended electrode 171 are applied with data voltages of opposite polarities, thus having a significant voltage difference. The greater a voltage difference between the extended electrode 171 and the pixel electrode 151, the stronger the lateral fields.

The stronger the fringe fields and the lateral fields are, the faster a response speed of the liquid crystal layer is. If the fringe fields and the lateral fields are strong, a desired response speed can be obtained even if the size of the pixel electrode 151 is increased to improve an aperture ratio.

In the present embodiment, since data voltages with different polarities are respectively applied to the pixel electrode 151 and the extended electrode 171 adjacent to the pixel electrode 151 within a pixel P, a voltage difference between the pixel electrode 151 and the extended electrode 171 significantly increases, resulting in strengthening the lateral fields.

Effects of the extended electrode 171 according to exemplary embodiments of the present invention will be described below.

First, a response speed of the liquid crystal layer 250 increases due to the strengthened lateral field. Second, it is possible to improve an aperture ratio by reducing the width d2 of the pixel electrode incision pattern 152 by the strengthened amount of the lateral field. The width d2 of the pixel electrode incision pattern 152 is conventionally about 10, which can be reduced to about 8 or less (preferably, about 7). Third, it is also possible to increase an aperture ratio by increasing the size of the pixel electrode 151 by the strengthened amount of the lateral field.

As described above, the increase in the response speed generally conflicts with the increase in the aperture ratio. For example, increasing the size of the pixel electrode 151 to increase an aperture ratio generally weakens electric fields and decreases a response speed. However, according to exemplary embodiments of the present invention, it is possible to improve both a response speed and an aperture ratio by using the above structure including the extended electrodes 171.

An improvement effect in a response speed by the lateral fields has been verified through an experiment.

A response speed Tᵣ of liquid crystal is decided by summing a rising time Tₒₙ and a falling time T_{off}. In a normally black mode, the rising time Tₒₙ is defined as a time required to rise from transmissivity of 10% to transmissivity of 90%, and the falling time T_{off} is defined as a time required to fall from transmissivity of 90% to transmissivity of 10%. The falling time T_{off} is about 6 ms regardless of the type of a LCD, while the rising time Tₒₙ is greatly influenced by the type of an LCD. If a response speed Tᵣ of liquid crystal is slow, a motion blur phenomenon occurs and display quality deteriorates.

A reference response speed of liquid crystal is generally 16 ms at a driving frequency of 60 Hz for implementing moving images. Accordingly, if the rising time Tₒₙ is 10 ms, no difficulty exists in implementing moving images. In the experiment, a maximum domain width in which the rising time Tₒₙ falls below 10 ms is obtained. In the experiment, it is assumed that a black voltage V_{b} is 1.25V and a pretilt voltage Vₚᵣₑₜᵢₗₜ is 2.5V or 2.7V. The pretilt voltage Vₚᵣₑₜᵢₗₜ is applied to increase the response speed of liquid crystal before a data voltage is applied. A pretilt voltage Vₚᵣₑₜᵢₗₜ lower than 2.7V has no influence on display quality.

Table 1 shows the experiment results.

TABLE 1

Vₚᵣₑₜᵢₗₜ

| | 2.5 V | 2.7 V |
|---|---|---|
| Fringe Field | 25 | 30 |
| Fringe Field + Lateral Field | 32 | 36 |

Referring to Table 1, if lateral fields are applied when the pretilt voltage Vₚᵣₑₜᵢₗₜ is 2.5 V, a rising time Tₒₙ shorter than 10 ms can be obtained even if the width of a domain increases from 25 to 32. If lateral fields are applied when the pretilt voltage Vₚᵣₑₜᵢₗₜ is 2.7V, a rising time Tₒₙ shorter than 10 ms can be obtained even if the width of a domain increases from 30 to 36.

Hereinafter, the experiment results of Table 1 will be described with reference to FIG. 4.

Fringe fields are weak or not applied in the center portion of each domain. Accordingly, since the liquid crystal layer 250 positioned in the center portion of each domain moves together with the movement of neighboring liquid crystal layers 250, a response speed becomes slow. However, in the third domain c, the area of liquid crystal layer 250 directly influenced by electric fields increases due to the influence of lateral fields, thereby increasing a response speed. Accordingly, by increasing the width d3 of the third domain c, a desired response speed can be obtained.

As seen in the results of Table 1, it is possible to increase the width of the third domain c to maximally 36. However, the width d4 of the fourth domain d to which no lateral field is applied is not increased.

Differently from the above embodiment, it is also possible to improve only the rising time Tₒₙ without increasing the width of the third domain c.

Referring to FIG. 1, the driving voltage generator 700 generates a gate on voltage Vₒₙ for turning on TFTs T, a gate off voltage V_{off} for turning off the TFTs T, a common voltage V_{com} to be applied to common electrodes 221, etc.

The gray scale voltage generator 800 generates a plurality of gray scale voltages related to the brightness of the LCD 1.

The gate driver 400, which is also called a scan driver, is connected to the gate lines 121, indicated as G1 to Gn in FIG. 1, and applies gate signals obtained by composing the gate on voltage Vₒₙ and the gate off voltage V_{off} received from the driving voltage generator 700 to the gate lines 121.

The data driver 500, which is also called a source driver, receives gray scale voltages from the gray scale voltage generator 800, selects gray scale voltages under the control of the signal controller 600, and applies the data voltages V_{d} to the data lines 141, indicated as D1 to Dm in FIG. 1.

The signal controller 600 generates control signals for controlling the operations of the gate driver 400, the data driver 500, the driving voltage generator 700, the gray scale voltage generator 800, etc., and supplies the control signals to the gate driver 400, the data driver 500, the driving voltage generator 700, the gray scale voltage generator 800, etc.

Hereinafter, the operation of the LCD 1 will be further described.

The signal controller 600 receives RGB gray scale signals R, G and B, input control signals (for example, a vertical synchronizing signal V_{sync} and a horizontal synchronizing signal H_{sync}, a main clock signal CLK, a data enable signal DE, etc.) for controlling the display of the RGB gray scale signals R, G and B, from an external graphic controller. The signal controller 600 generates a gate control signal, a data control signal, and a voltage selection control signal VSC based on the input control signals, transforms the gray scale signals R, G and B received from the external source into gray scale signals R′, G′ and B′ appropriately according to the operation conditions of the liquid crystal panel 300, then transfers the gate control signal to the gate driver 400 and the driving voltage generator 700, transfers the data control signal and the transformed gray scale signals R′, G′ and B′ to the data driver 500, and transfers the voltage selection control signal VSC to the gray scale voltage generator 800.

The gate control signal includes a vertical synchronization start signal STV for indicating an output timing of a gate on pulse (a high period of a gate signal), a gate clock signal CPV for controlling the output timing of the gate on pulse, a gate on enable signal OE for defining the width of the gate on pulse, etc. The gate on enable signal OE and the gate clock signal CPV are supplied to the driving voltage generator 700. The data control signal includes a horizontal synchronization start signal STH for indicating the reception of a gray scale signal, a load signal LOAD or TP for applying the corresponding data voltage V_{d} to a data line 141, an inversion control signal RVS for inverting the polarity of a data voltage, a data clock signal HCLK, etc.

First, the gray voltage generator 800 supplies a gray scale voltage having a voltage value decided according to the voltage selection control signal VSC, to the data driver 500.

The gate driver 400 sequentially applies a gate on voltage Vₒₙ to the gate lines 121 to turn on the TFTs T connected to the gate lines 121, according to a gate control signal received from the signal controller 600. Simultaneously, the data driver 500 receives an analog data voltage V_{d} as a data signal corresponding to a gray scale signal R′, G′ and B′ regarding a pixel P connected to a turned-on TFT T, from the gray scale voltage generator 800, and supplies the data signal to the corresponding data line 141, according to a data control signal received from the signal controller 600.

The data signal supplied to the data line 141 is applied to the corresponding pixel P through the turned-on TFT T. By sequentially applying the gate on voltage Vₒₙ to all gate lines 121 during a frame in this manner, the data signal is applied to all pixels P. If an inversion control signal RVS is supplied to the driving voltage generator 700 and the data driver 500 after one frame is terminated, the polarities of all data signals of a next frame are inverted.

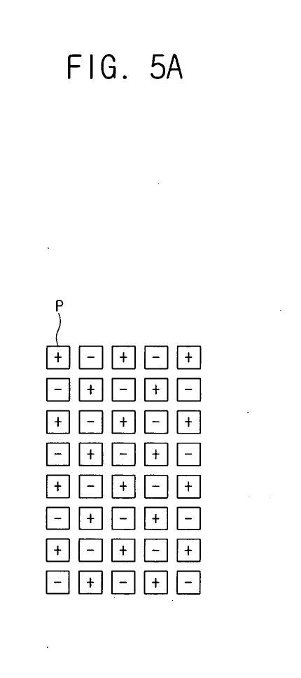

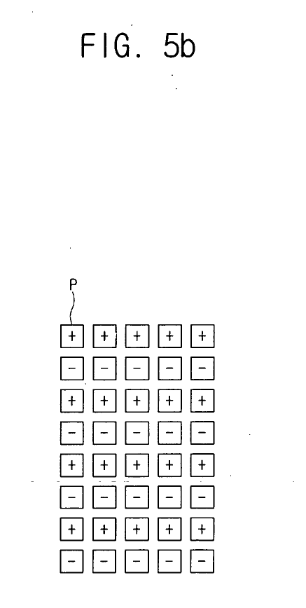

Hereinafter, inversion methods in which the polarities of data signals are inverted in a frame unit will be described with reference to FIGS. 5A and 5B.

According to a first exemplary embodiment, a data voltage of a front pixel P is applied to an extended electrode 171 passing between pixel electrode incision patterns 152 in a rear pixel P adjacent to the front pixel P, and a data voltage with a different polarity is applied to pixel electrodes 151 surrounding the extended electrode 171 in the rear pixel P. Accordingly, data voltages with different polarities are respectively applied to pixels P adjacent to each other in a vertical direction, that is, in the extended direction of data lines.

FIG. 5A is a view for describing a dot inversion method in which data voltages with different polarities are respectively applied to pixels P adjacent to each other in a horizontal direction as well as in a vertical direction, and the polarities of all pixels P are inverted in a next frame.

FIG. 5B is a view for describing a line inversion method in which data voltages with different polarities are respectively applied to pixels adjacent to each other in a vertical direction, that is, in the extended direction of data lines, and a data voltage with the same polarity is applied to pixels P adjacent to each other in a horizontal direction, that is, in the extended direction of gate lines.

Hereinafter, the function of the extended electrode 171 will be described when the line inversion method is used.

If a gate on voltage is applied to an n-th gate line 121, a driving TFT T1 and an additional TFT T2 connected to the n-th gate line 121 are simultaneously turned on. Due to the turning-on of the driving TFT T1, a positive or negative data voltage is applied to a pixel electrode 151 of a front pixel P connected to the driving TFT T1. Also, due to the turning-on of the additional TFT T2, a positive or negative data voltage is applied to an extended electrode 171 connected to the additional TFT T2 and extended to a rear pixel P, adjacent to the front pixel P.

Then, if the gate on voltage is applied to an (n+1)-th gate line 121 after one gate time elapses, the data voltage is applied to a pixel electrode 151 connected to the (n+1)-th gate line 121. The data voltage applied to the pixel electrode 151 connected to the (n+1)-th gate line 121 has a polarity opposite to the polarity of a voltage of the extended electrode 171, connected to the TFT T2 connected to the n-th gate line 121 and extending relative to a pixel electrode incision pattern 152 in the pixel electrode 151 connected to the (n+1)-th gate line 121, which are in advance charged by line inversion.

For example, if a common voltage is 6 V and a positive data voltage of 12V and a negative data voltage of 0V are applied to a pixel P, a voltage difference of 12V is formed between the pixel electrodes 151 connected to the (n+1)-th gate line 121 and the extended electrode 171 passing between the pixel electrodes 151. As such, since lateral fields are strengthened due to the great voltage difference and then a response speed increases, it is possible to increase the size of the pixel electrode 151.

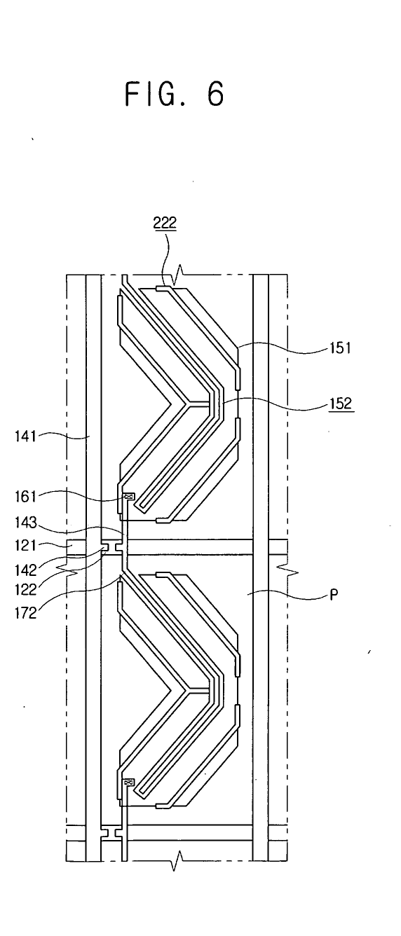

FIG. 6 is a layout of an exemplary TFT substrate according to a second exemplary embodiment of the present invention. In the second exemplary embodiment, an extended electrode 172 passing between pixel electrode incision patterns 152 in a rear pixel P is integrated with a drain electrode 143 of a front pixel P. Accordingly, the structure of the extended electrode 172 is simplified compared to the first exemplary embodiment, while strong lateral fields are obtained as in the first exemplary embodiment.

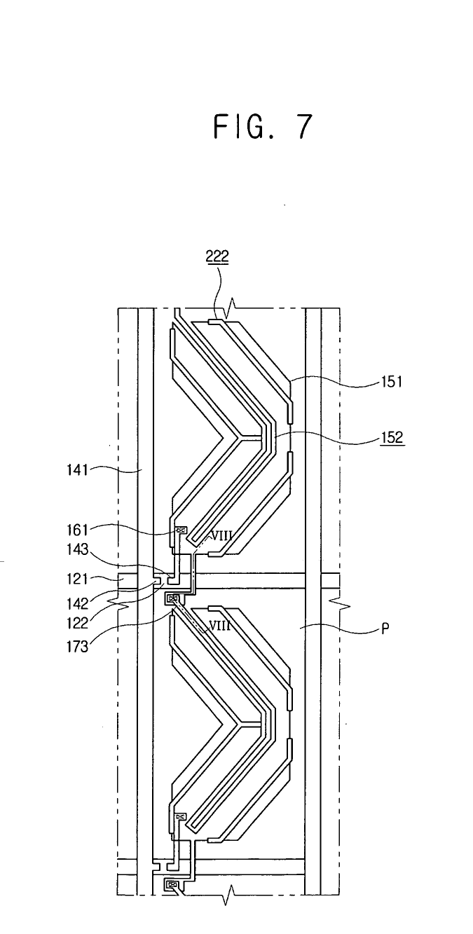

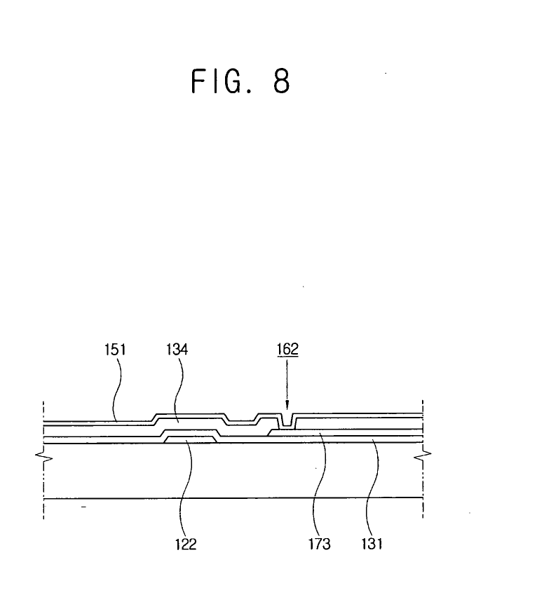

FIG. 7 is a layout of an exemplary TFT substrate according to a third exemplary embodiment of the present invention. FIG. 8 is a cross-sectional view cut along line VIII-VIII of FIG. 7.

Extended electrodes 173 are formed in the same layer of the TFT substrate 100 as the data lines 141. The extended electrodes 173 are not directly connected to TFTs as in the previously described embodiments, but instead are connected to pixel electrodes 151 of a front pixel P through lateral contact holes 162. Accordingly, a data voltage of the pixel electrodes 151 of the front pixel P is applied to the extended electrodes 173 extending in the rear pixel P, resulting in strengthening lateral fields.

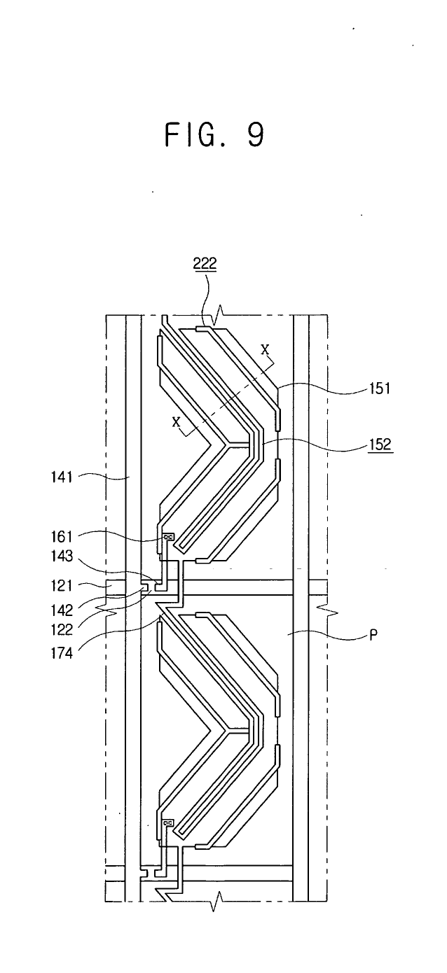

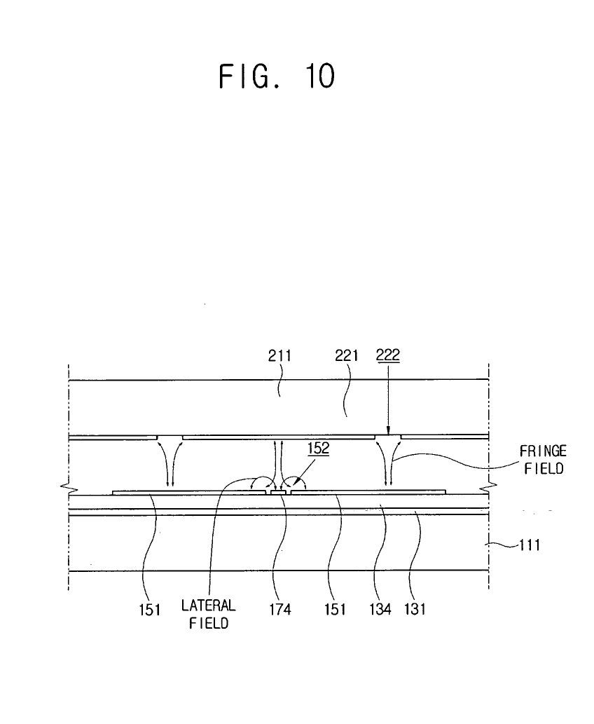

FIG. 9 is a layout of an exemplary TFT substrate according to a fourth exemplary embodiment of the present invention. FIG. 10 is a cross-sectional view of a liquid crystal panel cut along line X-X of FIG. 9.

Extended electrodes 174 are formed in the same layer as pixel electrodes 151. The extended electrodes 174 of a rear pixel P are directly connected to pixel electrodes 151 of a front pixel P. Accordingly, a data voltage of the pixel electrodes 151 of the front pixel P is applied to the extended electrodes 174 of the rear pixel P, resulting in strengthening lateral fields.

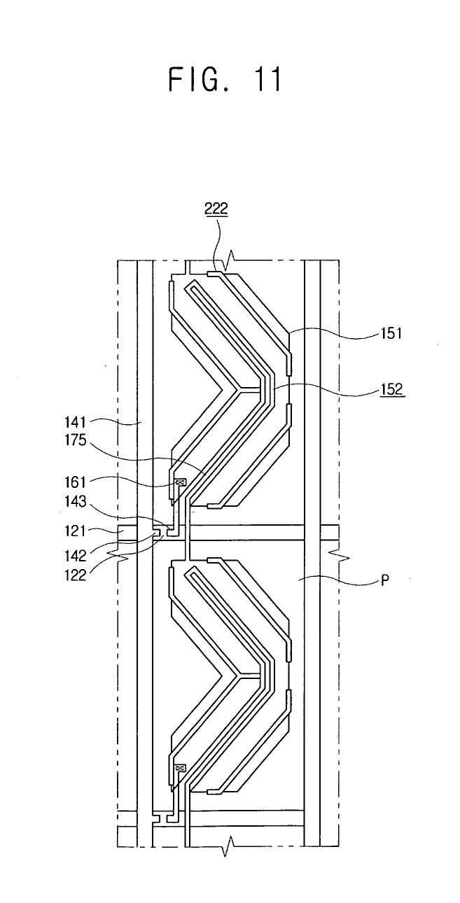

FIG. 11 is a layout of an exemplary TFT substrate according to a fifth exemplary embodiment of the present invention.

Extended electrodes 175 are formed in the same layer as pixel electrodes 151. The extended electrodes 175 of a front pixel P are directly connected to pixel electrodes 151 of a rear pixel P. Accordingly, a data voltage of the pixel electrodes 151 of the rear pixel P is applied to the extended electrodes 175 of the front pixel P, resulting in strengthening lateral fields.

In the second through fifth exemplary embodiments as described above, the LCD can be driven by a dot inversion method and a line inversion method.

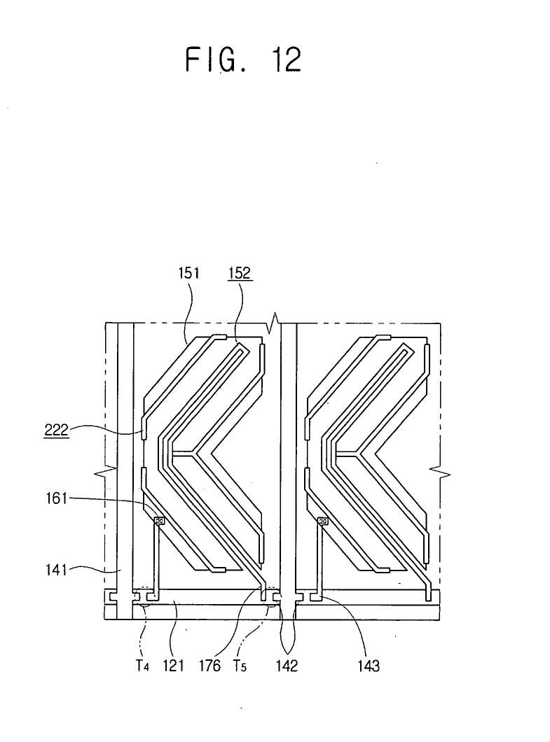

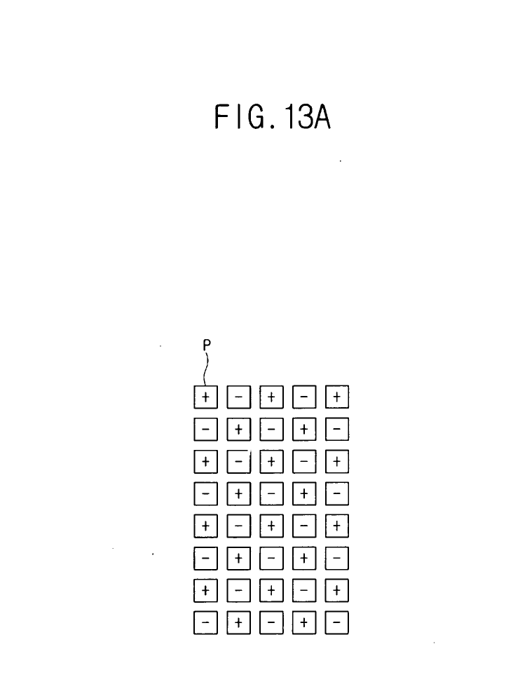

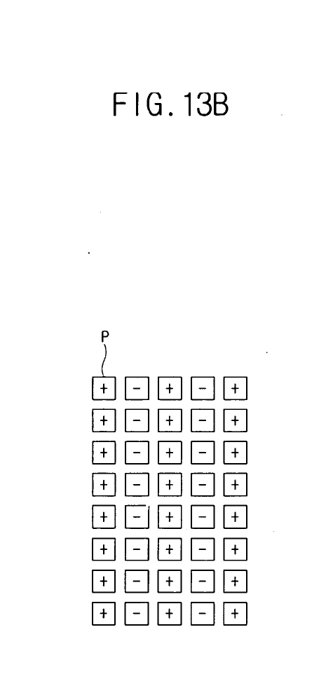

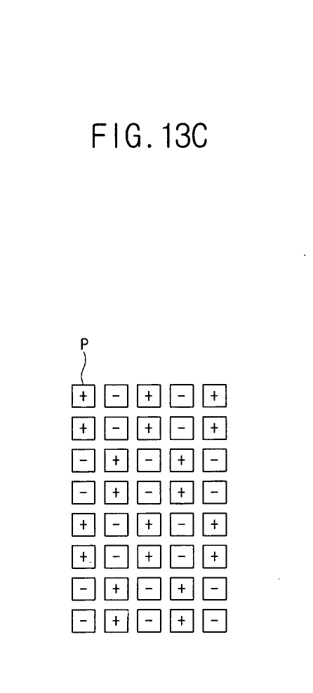

FIG. 12 is a layout of an exemplary TFT substrate according to a sixth exemplary embodiment of the present invention. FIGS. 13A, 13B and 13C are views for describing an inversion method of an exemplary LCD according to the sixth exemplary embodiment of the present invention.

The same data voltage is applied to an extended electrode 176 passing between pixel electrode incision patterns 152 in a first pixel P and to a second pixel P adjacent to the first pixel P in a horizontal direction, that is, in an extended direction of gate lines 121. In more detail, an extended electrode 176 extended to a first pixel P connected to a front data line 141 receives a data voltage from a rear data line 141. For this, a driving transistor T3 and a lateral transistor T4 are formed in each pixel P. In a first pixel P, a pixel electrode 151 is connected to the driving transistor T3 connected to a first data line 141 and a first gate line 121, and thus receives data voltages from the first data line 141. The extended electrode 176 extending in the first pixel P is connected to the lateral transistor T4 connected to a second data line 141 and the first gate line 121, and thus receives data voltages from the second data line 141.

In the sixth exemplary embodiment, data voltages with different polarities are applied to pixels P adjacent to each other in the extended direction of gate lines 121. Hereinafter, inversion methods in which the polarities of data voltages are inverted in a frame unit of the sixth exemplary embodiment will be described with reference to FIGS. 13A through 13C.

FIG. 13A is a view for describing a dot inversion method in which data voltages with different polarities are applied to pixels adjacent to each other in a horizontal direction as well as in a vertical direction. The polarities of all the pixels are inverted in the next frame.

FIG. 13B is a view for describing a column inversion method in which data voltages with different polarities are applied to pixels P adjacent to each other in a horizontal direction, that is, in the extended direction of the gate lines 121, while a data voltage with the same polarity is applied to pixels P adjacent to each other in a vertical direction, that is, in the extended direction of data lines 141.

FIG. 13C is a view for describing a 2-dot inversion method in which data voltages with different polarities are applied to pixels P adjacent to each other in a horizontal direction, that is, in the extended direction of the gate lines 121, while data voltages with different polarities are respectively applied to adjacent pixel pairs disposed in a vertical direction, that is, in the extended direction of data lines 141.

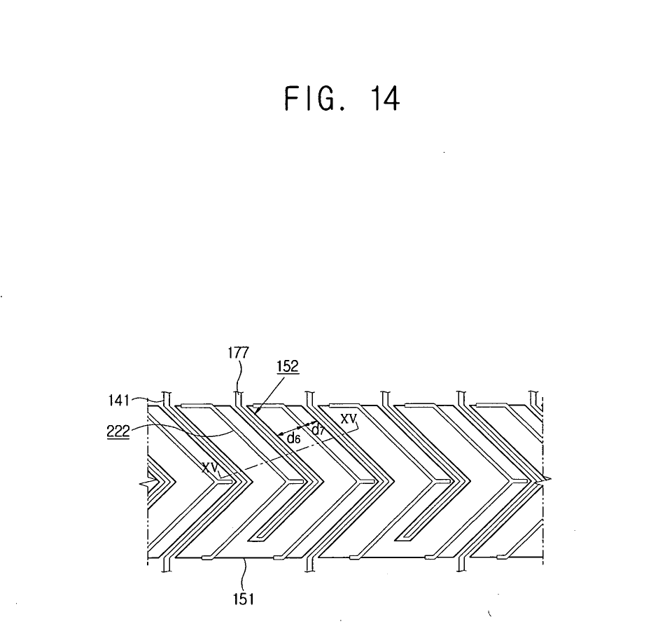

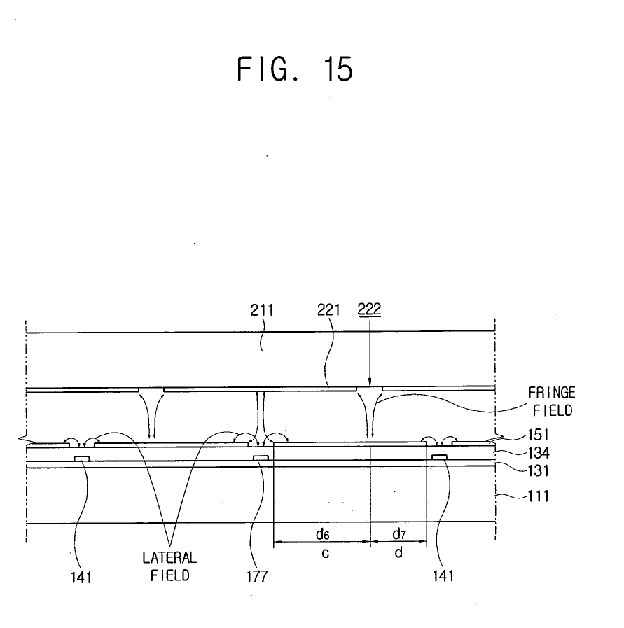

FIG. 14 is a layout of an exemplary TFT substrate according to a seventh exemplary embodiment of the present invention. FIG. 15 is a cross-sectional view of an exemplary liquid crystal panel cut along line XV-XV of FIG. 14.

Pixel electrodes 151 are shaped like a chevron, the general shape of a V character, (with a Z-cell structure) differently from the first through sixth exemplary embodiments, and data lines 141 are formed along the edges of the pixel electrodes 151, instead of extending in a relatively straight line. That is, the data lines 141 form a V-shape within each pixel P. An extended electrode 177 is connected to a front pixel and passes between a pixel electrode incision pattern 152 in a pixel electrode 151 in a rear pixel. The extended electrode 177 also forms a V-shape in each pixel P, following a V-shape of each pixel electrode incision pattern 152.

In the seventh exemplary embodiment, the edges of the pixel electrodes 151, the pixel electrode incision patterns 152, and common electrode incision patterns 222 are parallel to each other. In this structure, the direction of lateral fields generated between a data line 141 and a pixel electrode 151 is equal to a movement direction of the liquid crystal layer 250. Accordingly, a texture control ability is improved in the peripheral regions of the data lines 141, which improves an aperture ratio and a response speed.

In the seventh exemplary embodiment, lateral fields are generated between a data line 141 and a pixel electrode 151 adjacent to the data line 141. Since the polarity of a data voltage applied to the data line 141 successively varies, it can be considered that the same voltage as a common voltage is applied to the data line 141. Accordingly, a voltage difference between the data line 141 and the pixel electrode 151 is not great.

For example, if a common voltage is 6V and a positive data voltage of 12V and a negative data voltage of 0V are applied to a pixel, a voltage difference of about 12V is generated between the extended electrode 177 and the pixel electrode 151 having different polarities within a pixel P, while a voltage difference of about 6 V is generated between the data line 141 and the pixel electrode 151. Accordingly, a lateral field formed between the data line 141 and the pixel electrode 151 is weaker than a lateral field formed between the extended electrode 177 and the pixel electrode 151, and a width d7 of a fourth domain d adjacent to data line 141 is narrower than a width d6 of a third domain c adjacent to extended electrode 177.

The inversion method according to the seventh exemplary embodiment includes the dot inversion method and the line inversion method as shown in FIGS. 5A and 5B.

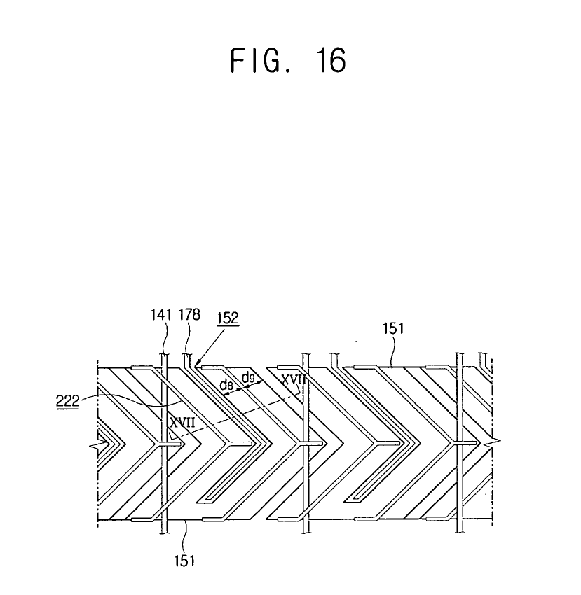

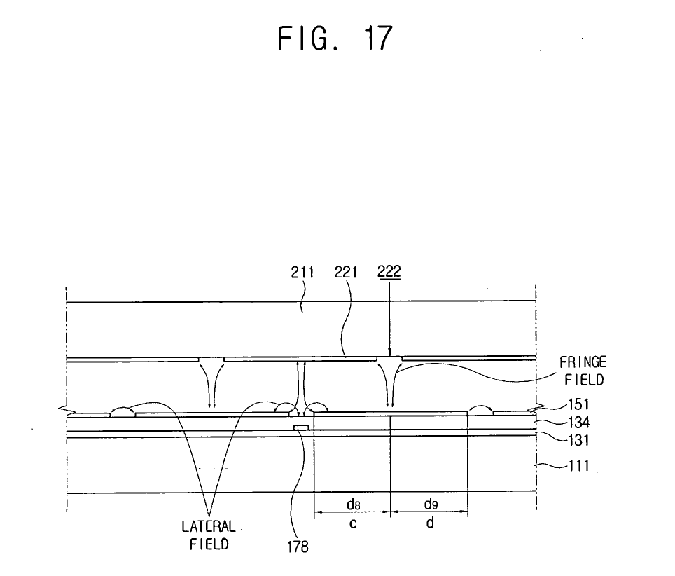

FIG. 16 is a layout of an exemplary TFT substrate according to an eighth exemplary embodiment of the present invention. FIG. 17 is a cross-sectional view of a liquid crystal panel cut along line XVII-XVII of FIG. 16.

Pixel electrodes 151 are chevron-shaped as in the seventh exemplary embodiment, however, data lines 141 in the eighth exemplary embodiment as illustrated in FIG. 16 are formed in a substantially straight line instead of being formed along the edges of pixel electrodes 151. An extended electrode 178 is connected to a front pixel and passes between pixel electrode incision patterns 152 in a pixel electrode 151 of a rear pixel.

In the eighth exemplary embodiment, no lateral field is generated between the data lines 141 and the pixel electrodes 151. Meanwhile, lateral fields are generated between pixel electrodes 151 adjacent to each other in the extended direction of gate lines 121. Here, data voltages with different polarities are applied to pixel electrodes 151 adjacent to each other in the extended direction of the gate lines 121. In this structure, the lateral fields formed between the adjacent pixel electrodes 151 are substantially equal to lateral fields formed between the extended electrodes 177 and the pixel electrodes 151.

For example, if a common voltage is 6V and a positive data voltage of 12V and a negative data voltage of 0V are applied to a pixel, a voltage difference of about 12 V is generated between the extended electrode 178 and the pixel electrode 151 having different polarities, and also a voltage difference of about 12 V is generated between adjacent pixel electrodes 151 having different polarities. Accordingly, it is possible to increase a width d8 of a third domain c adjacent to extended electrode 178 and a width d9 of a fourth domain d adjacent to a pixel electrode 151 of an adjacent pixel to maximally 36, and increase the widths of areas A and B of a pixel electrode 151 to 60 or 70.

In the eighth exemplary embodiment, in order to apply data voltages with different polarities to the extended electrode 178 and the pixel electrode 151 adjacent to the extended electrode 178, line inversion is needed. Also, in order to apply data voltages with different polarities to pixel electrodes 151 adjacent to each other in the extended direction of gate lines 121, column inversion is needed. Accordingly, in order to implement the eighth exemplary embodiment, dot inversion is required.

Meanwhile, although not illustrated in the drawings, in order to reduce interference between the data line 141 and the pixel electrode 151, the passivation layer 134 may include a thick organic film.

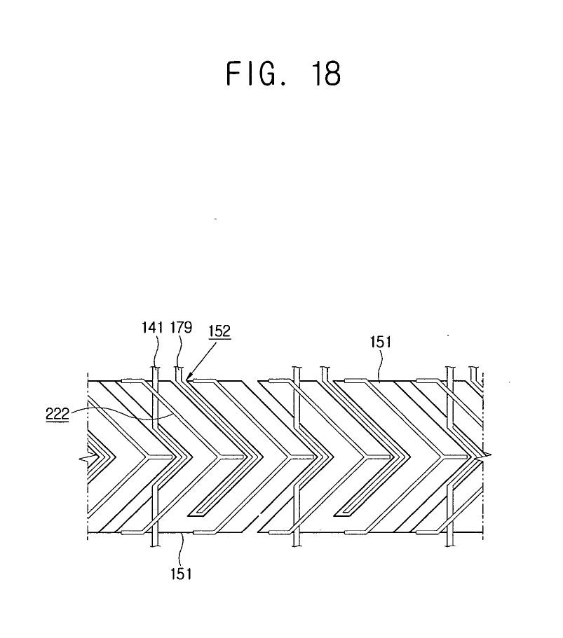

FIG. 18 is a layout of an exemplary TFT substrate according to a ninth exemplary embodiment of the present invention.

Pixel electrodes 151 are chevron-shaped as in the seventh exemplary embodiment. Portions of data lines 141 are formed in a straight line instead of being forming along the edges of pixel electrodes 151 and remaining portions of the data lines 141 are formed along the edges of the pixel electrodes 151 in a V-shape. An extended electrode 179 is connected to a front pixel and passes between pixel electrode incision patterns 152 in a pixel electrode 151 of a rear pixel.

By increasing the sizes of pixel electrodes according to exemplary embodiments of the present invention, a PVA mode, particularly, a Z-cell structure can be applied to LCDs having various pixel sizes. The size of a pixel depends on the size and resolution of a liquid crystal panel. According to exemplary embodiments of the present invention, since the width of each domain can increase to maximally 36, a Z-cell structure can be applied to an LCD having relatively large-sized pixels.

As described above, according to exemplary embodiments of the present invention, provided is an LCD which is capable of increasing a response speed and/or an aperture ratio.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A liquid crystal display apparatus comprising:
at least one gate line and at least one data line insulated from each other and intersecting each other;
a first pixel including a first thin film transistor disposed at an intersection of a gate line and a data line, a first pixel electrode connected to the first thin-film transistor and having an incision pattern, and an extended electrode having at least one part formed along the incision pattern;
a second pixel including a second thin-film transistor disposed at an intersection of a gate line and a data line, and a second pixel electrode to which a same data voltage as a data voltage applied to the extended electrode of the first pixel is applied;
a data driver applying a data voltage to the first pixel and the second pixel; and
a signal controller controlling the data driver so that data voltages with different polarities are applied to the first pixel and the second pixel.

2. The liquid crystal display apparatus according to claim 1, further comprising:
a third thin-film transistor receiving a same gate on voltage and the same data voltage as those applied to the second thin-film transistor,
wherein a part of the extended electrode is included in the third thin-film transistor.

3. The liquid crystal display apparatus according to claim 1, wherein the extended electrode is integrated with a drain electrode of the second thin-film transistor.

4. The liquid crystal display apparatus according to claim 3, wherein the extended electrode forms a same layer as the data line.

5. The liquid crystal display apparatus according to claim 1, wherein the extended electrode is connected to the second pixel electrode.

6. The liquid crystal display apparatus according to claim 5, wherein the extended electrode forms a same layer as the second pixel electrode.

7. The liquid crystal display apparatus according to claim 1, wherein the first pixel and the second pixel are connected to a same data line and are adjacent to each other in an extended direction of the same data line.

8. The liquid crystal display apparatus according to claim 7, wherein the first pixel is connected to a second gate line and the second pixel is connected to a first gate line.

9. The liquid crystal display apparatus according to claim 1, wherein the first pixel and the second pixel are connected to a same gate line are disposed in an extended direction of the same gate line.

10. The liquid crystal display apparatus according to claim 9, wherein the first pixel is connected to a first data line and the second pixel is connected to a second data line.

11. The liquid crystal display apparatus according to claim 1, wherein the first pixel electrode is chevron-shaped.

12. The liquid crystal display apparatus according to claim 11, wherein the data line connected to the first thin film transistor is formed in correspondence to an edge of the first pixel electrode.

13. The liquid crystal display apparatus according to claim 11, wherein the data line connected to the first thin film transistor is formed in a straight line.

14. The liquid crystal display apparatus according to claim 13, wherein a polarity of a data voltage applied to the first pixel is different from a polarity of a data voltage applied to pixels adjacent to the first pixel in an extended direction of the data line connected to the first thin film transistor and in an extended direction of the gate line connected to the first thin film transistor.

15. The liquid crystal display apparatus according to claim 1, wherein the incision pattern is at an acute angle to an extended direction of the gate line connected to the first thin film transistor.

16. The liquid crystal display apparatus according to claim 15, wherein the incision pattern is at an angle of about 45° to the extended direction of the gate line connected to the first thin film transistor.

17. The liquid crystal display apparatus according to claim 1, wherein the first pixel electrode is chevron-shaped, and the incision pattern is parallel to an edge of the first pixel electrode.

18. The liquid crystal display apparatus according to claim 17, wherein the first pixel electrode is divided into a first area and a second area both having a substantially same size and electrically connected to each other, wherein the incision pattern is disposed between the first area and the second area.

19. The liquid crystal display apparatus according to claim 18, wherein widths of the first area and the second area are respectively 60 or more.

20. The liquid crystal display apparatus according to claim 1, wherein a width of the extended electrode is narrower than a width of the incision pattern.

21. The liquid crystal display apparatus according to claim 1, wherein a width of the incision pattern is 8 or less.

22. A liquid crystal display apparatus comprising:
at least one gate line and at least one data line insulated from each other and intersecting each other;
a first thin-film transistor disposed at an intersection of a gate line and a data line and to which a data voltage with a first polarity is applied;
a second thin-film transistor disposed at an intersection of a gate line and a data line and to which a data voltage with a second polarity different than the first polarity is applied;
a pixel electrode connected to the first thin-film transistor and having a first area and a second area opposite to each other; and
an extended electrode electrically connected to the second thin-film transistor and disposed between the first area and the second area.

23. The liquid crystal display apparatus according to claim 22, wherein the first thin-film transistor and the second thin-film transistor are disposed in an extended direction of a same data line, such that the first thin-film transistor is connected to a second gate line and the second thin-film transistor is connected to a first gate line.

24. The liquid crystal display apparatus according to claim 22, wherein the first thin-film transistor and the second thin-film transistor are disposed in an extended direction of a same gate line, such that the first thin-film transistor is connected to a first data line and the second thin-film transistor is connected to a second data line.

25. The liquid crystal display apparatus according to claim 22, wherein the pixel electrode is chevron-shaped and the at least one data line is formed in a straight line.

26. The liquid crystal display apparatus according to claim 25, wherein the pixel electrode is subjected to dot inversion.

27. A liquid crystal display apparatus comprising:
a first substrate including a pixel electrode having a pixel electrode incision pattern, and an extended electrode formed along the pixel electrode incision pattern and to which a data voltage with a different polarity than the pixel electrode is applied;
a second substrate including a common electrode disposed opposite to the first substrate, wherein a common electrode incision pattern is formed in the common electrode; and
a liquid crystal layer positioned between the first substrate and the second substrate and of which dielectric anisotropy is negative.

28. A method of enhancing lateral fields in a liquid crystal layer of a liquid crystal display apparatus, the method comprising:
applying a data voltage of a first polarity to a pixel electrode of a first pixel, the pixel electrode having an incision pattern; and,
applying a data voltage of a second polarity opposite to the first polarity to an extended electrode extending in the first pixel in a direction following the incision pattern;
wherein a voltage difference between the extended electrode and the pixel electrode enhances the lateral fields.

29. The method according to claim 28, wherein applying a data voltage of a second polarity to the extended electrode includes applying the data voltage of the second polarity to a second pixel electrode of a second pixel adjacent the first pixel, the extended electrode electrically connected to the second pixel electrode.
